(19) United States
(12) Patent Application Publication
(10) Pub. No.: US 2011/0082994 A1
(43) Pub. Date: Apr. 7, 2011

(54) ACCELERATED RELOCATION CIRCUIT

(75) Inventors: Aravind Dasu, Providence, UT (US); Ramachandra Kallam, Logan, UT (US)

(73) Assignee: Utah State University, North Logan, UT (US)

(21) Appl. No.: 12/899,352

(22) Filed: Oct. 6, 2010

Related U.S. Application Data
(60) Provisional application No. 61/249,071, filed on Oct. 6, 2009.

(51) Int. Cl. G06F 12/02; G06F 12/00

(52) U.S. Cl. 711/165; 711/E12.001; 711/E12.002

(57) ABSTRACT

A Partial bitstream relocation method to generates source and destination addresses on Field Programmable Gate Arrays. The bitstream from an active source is located and read in a nonintrusive manner, and written to a destination address. The accelerator runs in real time, moving source code on the fly. Code may be altered by mirror inversion for proper placement when necessary.

### RELATED APPLICATIONS

This application claims priority to U.S. Provisional Patent Application No. 61/249,071 titled “Accelerated Relocation Circuit” filed on Oct. 6, 2009, which is hereby incorporated herein by reference.

### GOVERNMENT LICENSE RIGHTS

The U.S. Government has a paid-up license in this invention and the right in limited circumstances to require the patent owner to license others on reasonable terms as provided for by the terms of NNGO6GE54G awarded by NASA.

### FIELD OF THE INVENTION

This invention relates to a method for Partial bitstream relocation on Field Programmable Gate Arrays.

### BACKGROUND

Partial bitstream relocation (PBR) on Field Programmable Gate Arrays (FPGAs) is a technique to scale parallelism of accelerator architectures at run time and enhance fault tolerance. PBR techniques have focused on reading inactive bitstreams stored in memory, on-chip or off-chip, whose contents are generated for a specific partial reconfiguration region (PRR) and modified on demand for configuration into a PRR at a different location. As an alternative, we disclose a PRRPRR relocation method to generate source and destination addresses, read the bitstream from an active PRR (source) in a nonintrusive manner, and write it to destination PRR. We describe two embodiments of realizing this on Xilinx Virtex 4 FPGAs: (a) hardware based accelerated relocation circuit (ARC) and (b) a software solution executed on Microblaze. A comparative performance analysis to highlight the speed-up obtained using ARC is presented. Performance realizations of the current embodiments are compared to estimated performances of two state of the art methods.

Emerging reconfiguration techniques that include partial dynamic reconfiguration (PDR) and partial bitstream relocation (PBR) have been addressed in the past in order to expose the flexibility of FPGAs at run time. PBR is a technique used to target a partial bitstream of a PRR onto other identical PRRs inside an FPGA, while PDR is used to target a single PRR. Fast PBR techniques are required to support certain fault-tolerant applications, where time to replace a faulty circuit with the correct circuit (using relocation) and restart the computation is critical to the performance. Other applications that require fast PBR include rapid rescaling of kernels for navigation and image processing in satellites. Another application is the ability to move circuits around in a 3D FPGA stack to mitigate hot-spot formation. Techniques for PBR can be classified based on the following five criteria: (a) Location of processor that manipulates the bitstream: on-chip or off-chip (b) Type of on-chip processor: hardware or software (c) Bitstream storage for on-chip processing: on-chip Block RAMs (BRAMs) or off-chip Flash memory (d) Type of wrapper used to communicate with Internal Communication Access Port (ICAP): Xilinx provided hardware ICAP (HWICAP) or a custom wrapper. Type of relocation supported: relocation to identical or non-identical PRRs. Existing works on PBR are analyzed based on these criteria. PARBIT is one of the earliest tools developed to support PBR. This tool runs on an off-chip processor. It extracts a partial bitstream from a bitstream file and transforms it to be relocated to a new PRR. pBITPOS is one of the earliest tools that can relocate BRAMs and 18×18 Multipliers. This tool is similar to PARBIT and targets Virtex II and Virtex II Pro family of FPGAs. REPLICA is a dedicated hardware relocation filter that transforms the bitstream when it is being downloaded from off-chip memory. This approach targets Virtex-E devices, can relocate to identical PRRs, and has no support for relocating PRRs containing BRAMs or 18×18 Multipliers. The next version, REPLICA2Pro is similar to REPLICA, but has support for relocating PRRs containing BRAMs and 18×18 Multipliers, and targets Virtex II and Virtex II Pro family of FPGAs. While REPLICA is implemented using an additional FPGA device, REPLICA2Pro is implemented on the same FPGA as the one containing source and destination PRRs. Both use a custom wrapper to communicate with ICAP. BiRF is yet another hardware-based relocation filter that communicates to the ICAP via a custom wrapper. In addition to Virtex II Pro FPGAs, this approach can target Virtex 4 and 5 series of FPGAs. A software-based approach to perform relocation and use an embedded processor (Microblaze) to transform the relocatable bitstream has been proposed. Communication to ICAP is provided via the Xilinx HWICAP wrapper. Prior work has transformed the relocatable bitstream on an embedded Microblaze processor. However, they rely on on-chip BRAM to store a copy of the bitstream. They target Virtex 4 series of FPGAs. Another method is novel compared to all of the above techniques because they have the ability to relocate to non-identical regions on a device. They read a bitstream from off-chip Flash memory and relocate using software running on an embedded Microblaze processor talking to the HWICAP wrapper. All of the above techniques rely on reading a copy of a bitstream residing in memory. Memory requirements are satisfied in two ways: (i) Using on-chip BRAMs, which are limited and expensive and (ii) Using off-chip memories, which are slow. We disclose a novel PRR-PRR relocation technique to read frame data (not the entire partial bitstream) directly from an active PRR and relocate it to a destination PRR on the fly, thus accelerating the relocation and removing the need to store any temporary copies of bitstreams. We have realized embodiments of this technique both in hardware and software. An analytical model used to evaluate the performance of PRRPRR relocation algorithm and highlight the speed-up obtained by the proposed hardware implementation.

### BRIEF DESCRIPTION OF THE DRAWINGS

FIG. 1. Top-level methodology of proposed PRR-PRR relocation technique

FIG. 2. (a) Illustration of hardware implementation of proposed PRR-PRR relocation, (b) Top-level block of diagram of ARC

FIG. 3. Outline of GenerateFAR

FIG. 4. Flow diagram

### DETAILED DESCRIPTION

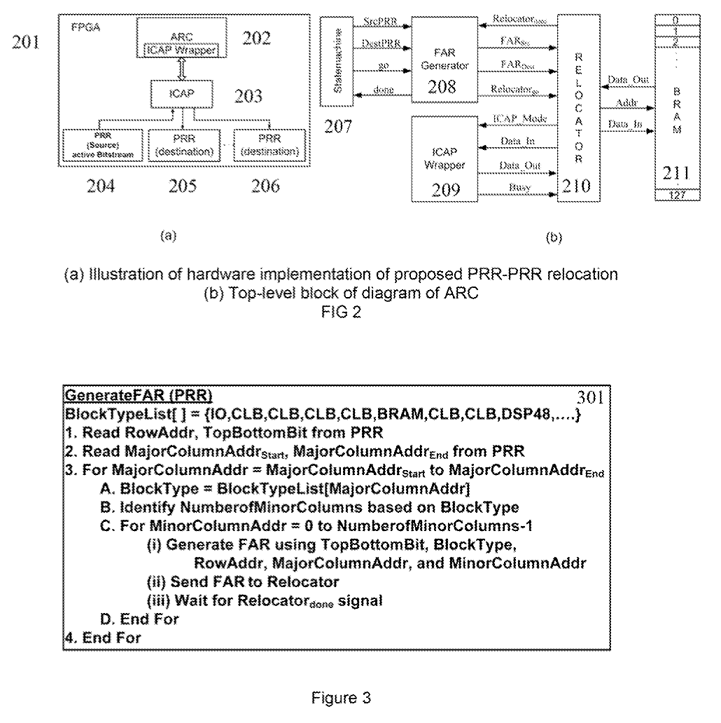

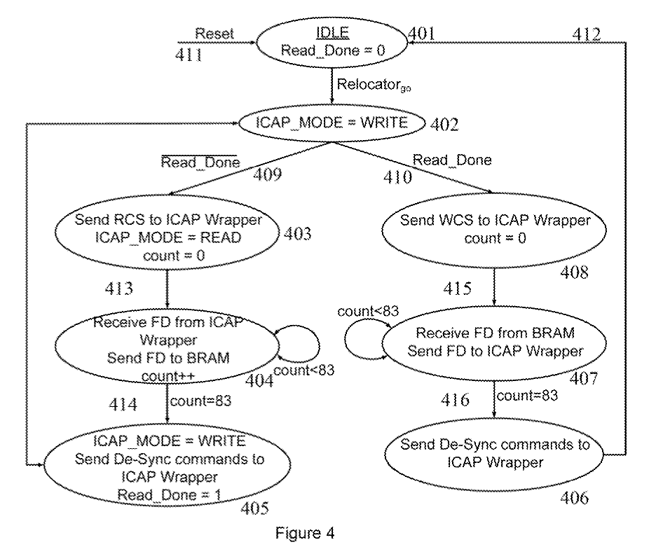

FIG. 2 shows the top-level block diagram of ARC. ARC consists of three main components: (1) FAR Generator 208 (2) Relocator 210 and (3) ICAP Wrapper 209. Locations of the source 204 and destination PRRs 205, 206 are represented using two 16-bit words (SrcPRR and DestPRR). The 16-bits are divided into 4 sections, top/bottom bit (1 bit), row address (5 bits), starting Major Column (5 bits) and ending Major Column (5 bits). SrcPRR, DestPRR and the control signals (reset and go) are received from the Microblaze, or any on-chip soft processor in a Xilinx Virtex 4 FPGA. An advantage of ARC is that the top-level controller logic is simple and can also be realized using a simple state machine 207 instead of code on a Microblaze processor. The sub-modules of ARC are described herein.

FAR Generator 208 is responsible for decoding SrcPRR and DestPRR and use the decoded information to generate the complete sequence of frame addresses for the source 204 and destination PRRs 205, 206. Functionality of the FAR Generator 208 is shown in FIG. 2. FAR Generator 208 executes two instances of the GenerateFAR module 301 to decode SrcPRR and DestPR and generate FAR_{Src} and FAR_{Dest}Upon generation of both FAR_{Src} and FAR_{Dest}, a control signal (Relocator_{go}) is sent to the Relocator 210. Proposed FAR Generator 208 is capable of autonomous generation of the complete sequence of FARs for relocating an entire PRR. Information about the type of block (BlockType ε {DSP48,CLB,BRAM}) corresponding to a major column address is required for generating an FAR and the sequence of BlockTypes (BlockTypeList) can be derived for any given Virtex 4 FPGA. After generating a single FAR, each instance of the GenerateFAR module 301 waits for the Relocator_{done} signal before generating the next FAR.

The architecture for the Relocator module 101 is governed by a state machine 207. Based on the values of FAR_{Src} and FAR_{Dest}, the Relocator module 101 reads one frame from the source PRR and writes the frame to the destination PRR. Functionality of the Relocator module is split into two phases: (i) Readback phase (Read_Done=0) and (ii) Write phase (Read_Done=1). During the readback phase, the Relocator module sets the mode of ICAP 209 operation (ICAP_MODE) to “write” and then sends the Readback Command Sequence (RCS) to ICAP. RCS consists of the following: (a) commands to synchronize with the ICAP (b) command to set the command register (CMD) to read configuration, (c) FAR_{Src} and (d) number of words to read from ICAP. After sending RCS, the Relocator sets the ICAP into “read” mode to read one frame. To read one frame from ICAP, it is required to read a combination of 83 words that includes one dummy word, one pad frame (41 words) and one data frame (41 words). This combination is represented as Frame Data (FD). A Block RAM (BRAM) module is used to temporarily store the FD. After the FD is read, the Relocator sets the ICAP_MODE to “write” 402 and sends the de-sync commands to ICAP. Now, readback phase is completed and the writing phase begins. In this phase, a Write Command Sequence (WCS), which contains FAR_{Dest}, is written to the ICAP 408. FD is now fetched from BRAM and sent to the ICAP in a specific order 407. The data frame is written first followed by the pad frame. The de-sync commands are now sent to the ICAP, after which the Relocator_{done} signal is sent to FAR Generator which generates the next pair of FARs. This process goes on until all the frames in the source PRR are relocated to the destination PRR, after which the FAR Generator sends a ‘done’ signal to the Microblaze. It is observed that additional processing is required to relocate the design, if the source and destination regions are located on opposite halves of the chip. Data coming out of the ICAP needs to be bit reversed 103 and stored in the BRAM as a mirror image to the actual frame. In the proposed architecture, this processing is performed on the fly, thereby removing any possible timing overhead at the cost of minimal area overhead (for bit reversal).

ICAP wrapper acts as an interface between Relocator and the ICAP ports (data and control). It decodes the information sent by Relocator (ICAP_MODE) to generate the control signals for ICAP.

### PRR-PRR Relocation

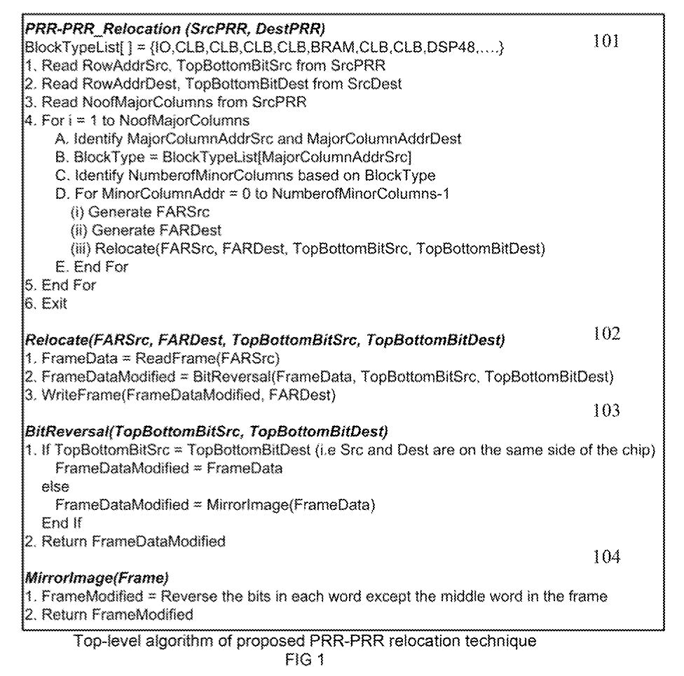

A partial bitstream associated with a PRR can be described as a combination of two components: (i) frame data (FD) and (ii) commands to synchronize/desynchronize with the ICAP, write a frame and cyclic redundancy check (CRC) processing. We access FD from an active PRR, and write it back to an identical destination PRR. Source and destination addresses are generated on the fly. FIG. 1 outlines the toplevel algorithm of one embodiment of the PRR-PRR relocation technique. Sub-modules are also listed in this figure. An analytical model that can be used to estimate and analyze performance for a given partial reconfigurable design. In this discussion, time is measured in terms of number of clock cycles and a word represents 32 bits. The proposed relocation algorithm operates on multiple frames (one frame at a time). Number of frames (nFrames) depends on two factors: (1) Design size (2) Generation of PRR using early access partial reconfiguration (EAPR) tool flow from Xilinx. Time to relocate each frame is composed of top three variables listed in Table 1.

Overall time taken to relocate all the frames in the source PRR is calculated as shown in Equation 1.

T_{Overall}=nFrames×(T_{readFD}+T_{writeFD}+isOppHalf+T_{bitReversal}) Equation 1

TABLE 1

| Name | Description |
|---|---|
| T_{readFD} | Time taken to read FD from ICAP |
| T_{bitReversal} | Time take to reverse bits in case the frame is |
| | relocated to the opposite half of the FPGA |
| T_{writeFD} | Time taken to write FD to ICAP |
| T_{gen}^{syncRdCmds} | Time take to generate set-up commands, and store |
| | them in buffer |
| T_{writeICAP}^{syncRdCmds} | Time taken to write set-up commands to ICAP |
| T_{readICAP}^{FD} | Time taken to read FD from ICAP |
| T_{gen}^{desyncCmds} | Time taken to generate de-synchronization |
| | commands, and store them in a buffer |
| T_{writeICAP}^{desyncCmds} | Time taken to write de-synchronization commands |
| | to ICAP |

Variables used in the proposed performance model

Reading FD from ICAP is a three step process. First, a sequence of set-up commands to synchronize with ICAP and setting it in “read” mode are generated and written to ICAP. This is followed by the actual process of reading the FD from ICAP and storing it in a buffer. Finally, a sequence of desynchronization commands are generated and sent to ICAP to terminate the reading process. Writing data to ICAP is a similar process, and the only difference lies in the sequence of set-up commands sent to the ICAP. Time taken to read FD is computed as the sum of the last five variables listed in Table 1. Similarly, time taken to write FD can also be computed.

There are three fundamental components of the proposed performance model: T_{gen}^{α}, and T_{writeICAP}^{β}, T_{readICAP}^{γ}. Each of these fundamental components (ex. T_{writeICAP}^{β}) depend on the number of words in the data being processed (β) and are computed as sum of T_{overheadW} and T_{write(χ)}. Here T_{overheadW} is the time taken to write ‘zero’ words to ICAP. In other words, it is the time taken to start writing to the ICAP. T_{write(χ)} is the time taken to write χ words to the ICAP, where χ is the number of words in the data being written to ICAP (β). Both T_{overheadW} and T_{write(χ)} depend on the type of implementation and the type of interface used to communicate with ICAP. Similar formulas to compute T_{gen}^{α} and T_{readICAP}^{γ} are also utilized.

### PRR-PRR Hardware

Based on the values of FARSrc and FARDest, the Relocator module reads one frame from the source PRR and writes the frame to the destination PRR 102. Functionality of the Relocator module is split into two phases: (i) Read phase and (ii) Write phase. During the read phase, the Relocator module sets the mode of ICAP operation (ICAP MODE) to “write” 402 and then sends the sequence of commands to set-up the ICAP for reading. After sending this sequence, the Relocator sets the ICAP into “read” mode to read one frame. To read one frame from ICAP, we read a combination of 83 words that includes one dummy word, one pad frame (41 words) and one data frame (41 words). In this paper, this combination is represented as FD. A BRAM module 211 is used to temporarily store the FD. After the FD is read, the Relocator sets the ICAP MODE to “write” and sends the de-synchronization commands to ICAP. Now, read phase is completed and the write phase begins. In this phase, a sequence of commands to set-up the ICAP for writing is sent to the ICAP. FD is now fetched from BRAM and sent to the ICAP in a specific order. The data frame is written first followed by the pad frame. The de-synchronization commands are now sent to the ICAP, after which the Relocator_{done} signal is sent to FAR Generator which generates the next pair of FARs. This process goes on until all the frames in the source PRR are relocated to the destination PRR, after which the FAR Generator sends a ‘done’ signal to the top-level controller. It is observed that additional processing is required to relocate the design, if the source and destination regions are located on opposite halves of the chip. Data coming out of the ICAP needs to be bit reversed 103 and stored in the BRAM as a mirror image to the actual frame 104. In the proposed architecture, this processing is performed on the fly, thereby removing any possible timing overhead at the cost of minimal area overhead (for bit reversal). ICAP wrapper 202 acts as a simple interface between Relocator and the ICAP ports (data and control). It decodes the information sent by Relocator (ICAP_MODE) to generate the control signals for ICAP 203.

### PRR-PRR Software

This embodiment is executed on Xilinx Microblaze that talks to the ICAP using a proprietary hardware ICAP (HWICAP) core via the on-chip peripheral bus (OPB). Low-level device drivers are provided by Xilinx to communicate with HWICAP and we use these drivers to read all the frames from the source PRR and write it to an identical destination PRR.

### Performance Analysis

A comparative performance analysis of the hardware and software implementations of PRR-PRR relocation algorithm is provided here. Performance is estimated using the proposed analytical model for relocating a single frame. Table 2 shows a comparative listing (software vs ARC) of the various timing estimates for the variables defined in the proposed model.

TABLE 2

| Variable Name | # words | ARC | Software |
|---|---|---|---|
| T_{gen}^{α} | χ | 1 | f₁(χ) |
| T_{overheadW} | n/a | 4 | 81 |
| T_{overheadR} | n/a | 4 | 81 |
| T_{write}(χ) | χ | χ | f₂(χ) |
| T_{read}(χ) | χ | χ | f₃(χ) |
| TreadFD | n/a | 119 | 1175 |
| T_{writeFD} | n/a | 118 | 1614 |
| T_{bitReversal} | 82 | 0 | 13310 |
| Tₒᵥₑᵣₐₗₗ | n/a | 237 | 16099 |

Performance analysis of ARC versus software implementation

At different stages in the relocation process, a sequence of commands is generated. In the software implementation, the commands are generated in sequence and written to a buffer before writing it to ICAP 203. In hardware, the commands are hardcoded and written directly to ICAP 203. T_{gen}^{α} values for software implementation are much higher (for different α's). For the software implementation there is considerable overhead associated with the process of communicating with ICAP (T_{overheadW} and T_{overheadR}). Corresponding numbers for the hardware implementation are much smaller. Once the ICAP is ready, time taken to write (or read) χ words is χ clock cycles (in case of ARC) and is some function of χ (in case of software). Table 2 lists the values for other variables in the performance model and also lists the overall time. In this table, some values are represented as fᵢ(χ), which indicates that the value is a function of the number of words (χ) and is much larger than χ. In case of relocation to opposite half of FPGA, bit-reversal needs to be performed. This is a time consuming process in software as it involves reading the sequence of bits from the frame buffer into a temporary buffer, reversing the bits, and then storing it back into the original buffer. This process involves a large number of sequential memory transactions (in a software implementation) and takes 13310 clock cycles. In hardware, bit-reversal is performed on the fly, and does not require any additional clock cycles. Overall time taken for software is estimated to be 68× larger than that of ARC.

The disclosed method and hardware approaches were implemented and tested to run at 100 MHz on a Virtex 4 SX35 FPGA. Xilinx ISE tool flow is used to synthesize, map, place and route the design. Test cases used to evaluate the different approaches are of two types, as listed below.
1) Dynamically scalable systolic array designs. Number of processing elements (PE) can be increased during runtime, thus requiring the relocation of a single PE design to an empty PRR.
2) Fault tolerant designs. Relocation is required to replace a faulty circuit. Each design is implemented using the EAPR tool flow from Xilinx.

The method is applicable to any FPGA as long as source and destination PRRs are floor planned to have identical set of device primitives and routing resources. Accelerating relocation can have a major impact on performance, under two conditions: (i) Relocation time is comparable to actual execution time and (ii) Fast relocation is required to respond to a particular event.

This specification fully discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

What is claimed is:

1. A method to accelerate computational performance comprising:
locating target code on an FPGA,
identifying source address of said target code,
reading said target code from said source address,
identifying destination address, and
writing said target code to said destination address.

2. The method of claim 1, further comprising the step of inverting said target code before writing said inverted target code to said destination address.

3. The method of claim 1, further comprising a control mechanism to determine when to read and write said target code.

4. The method of claim 1, wherein said writing of said target code takes place during execution of programmed processes.

5. The method of claim 1, further comprising a step of creating a mirror image of said target code before writing said mirror image of said target code to said destination address.

6. The method of claim 1, wherein said destination target code and said destination are floor planned to have identical set of device primitives and routing resources.

7. The method of claim 1, wherein said source address is generated on the fly.

8. The method of claim 1, wherein said destination address is generated on the fly.

9. The method of claim 5, wherein said source address and said destination address are located on opposite halves of said FPGA.

10. The method of claim 9, wherein the step of creating a mirror image of said target code is performed on the fly.

11. The method of claim 1, wherein the step of reading said target code from said source address is a three step process.

12. The method of claim 11, wherein one step of reading said target code from said source address is a sequence of set-up commands to synchronize the process.

13. The method of claim 11, wherein one step of reading said target code from said source address is the actual process of reading said target code and storing said target code in a buffer.

14. The method of claim 11, wherein one step of reading said target code from said source address is, a sequence of desynchronization commands to terminate said reading process.
